(19) United States
(12) Patent Application Publication
(10) Pub. No.: US 2025/0113130 A1
(43) Pub. Date: Apr. 3, 2025

(54) SMART GLASSES MONOCOQUE TEMPLE ELECTRONICS ASSEMBLY

(71) Applicant: GOOGLE LLC, Mountain View, CA (US)

(72) Inventors: Eric Anthony Bokides, Boise, ID (US); Joshua Moore, Elora (CA); Adam Umar Abdul Kareem, Bolingbrook, IL (US); Emeka Godswill Ugwu, Oakland, CA (US); Daniel Corbalan, Forest Hills, NY (US); Jiwon Yang, Toronto (CA); Sheng-Kai Chang, Taipei City (TW); Che-Wei Liu, New Taipei City (TW); Coulter Eastwood, Kitchener (CA)

(21) Appl. No.: 18/478,120

(22) Filed: Sep. 29, 2023

(51) Int. Cl. H04R 1/02

(52) U.S. Cl. CPC H04R 1/025; H04R 1/028; H04R 2499/15

(57) ABSTRACT

A method for making smart glasses includes obtaining a monocoque temple pre-form made as a one-piece seamless shell structure with shell walls enclosing a hollow compartment. The hollow compartment has an open end and a bottom opposite the open end. The method further includes inserting a first pre-assembled smart glasses components module into the hollow compartment through the open end of the hollow compartment and disposing the first pre-assembled smart glasses components module at a bottom of the hollow compartment. The method further includes inserting a second pre-assembled smart glasses components module through the open end of the hollow compartment, electrically connecting the second pre-assembled smart glasses components module to the first pre-assembled smart glasses components module, and attaching the monocoque temple pre-form to a frame of the smart glasses.

### RELATED APPLICATION

This application is related to commonly owned and U.S. application Ser. No. 17/645,150, titled “MONOCOQUE SMART GLASSES TEMPLE PRE-FORM,” filed on Dec. 20, 2021, which is incorporated herein by reference in its entirety.

### FIELD

This disclosure relates to smart glasses that provide additional information alongside what a wearer sees through the glasses.

### BACKGROUND

Smart glasses (including, e.g., Optical Head-Mounted Display (OHMD), Augmented Reality (AR) glasses, or through Heads Up Display (HUD) glasses) are wearable devices that add information onto a user's field of view. Electronic and optical components of the smart glasses (e.g., electronic components such as processors, wireless transceivers, batteries, control buttons, in-lens or attached displays, etc.; audio components such as speakers, microphones, etc.; and optical components such as prisms, projectors, and cameras, etc.) (hereinafter “smart glasses components”) can generate and display additional information (e.g., on an in-lens display) alongside what the wearer sees through the glasses. Several of these smart glasses components are typically either attached to and protrude from a wearable frame of the smart glasses, or are enclosed in bulky box-like structures (i.e., legs or temples) attached to the frame. Consumers can find the smart glasses with bulky component structures unusual or uncomfortable to wear all day, and may prefer the shape, size, and form factor of regular glasses (e.g., regular glasses that are fashionably slim and stylish). However, even with increasing miniaturization of the components, the large number of smart glasses components needed to make the smart glasses function makes it challenging to balance functionality and wearability of the smart glasses.

Consideration is now being given to smart glasses that can have a large number of components fitted in a temple with a slim design or form factor.

### SUMMARY

In a general aspect, a method for making smart glasses includes obtaining a monocoque temple pre-form made as a one-piece seamless shell structure with shell walls enclosing a hollow compartment. The hollow compartment has an open end and a bottom opposite the open end. The method further includes inserting a first pre-assembled smart glasses components module into the hollow compartment through the open end of the hollow compartment and disposing the first pre-assembled smart glasses components module at a bottom of the hollow compartment. The method further includes inserting a second pre-assembled smart glasses components module through the open end of the hollow compartment, electrically connecting the second pre-assembled smart glasses components module to the first pre-assembled smart glasses components module, and attaching the monocoque temple pre-form to a frame of the smart glasses.

In a general aspect, a method includes disposing a speaker module at a bottom of a hollow tubular enclosure in a monocoque temple pre-form. The speaker module includes a speaker and associated electronics embedded in a plastic housing. A metal connector of the speaker module extends from the plastic housing.

The method further includes disposing a circuit board in the hollow tubular enclosure. A plurality of smart glasses components are mounted on the circuit board with at least a flexible tape connector electrically connecting at least one of the plurality of smart glasses components. The method further includes accessing, through an aperture in a sidewall of the monocoque temple pre-form, the metal connector of the speaker module and connecting the metal connector of the speaker module to the circuit board.

The details of one or more implementations are set forth in the accompanying drawings and the description below. Other features will be apparent from the description and drawings, and from the claims.

### BRIEF DESCRIPTION OF THE DRAWINGS

Example embodiments will become more fully understood from the detailed description herein and the accompanying drawings, wherein like elements are represented by like reference numerals, which are given by way of illustration only and thus are not limiting of the example embodiments.

FIG. 1 illustrates an example pair of smart glasses.

FIG. 2 illustrates an example monocoque temple pre-form that may be fitted with smart glasses components.

FIG. 3 illustrates a pre-assembled module that includes a smart glasses component (e.g., a speaker and speaker electronics) for fitting in example monocoque temple pre-form of FIG. 2.

FIG. 4 illustrates a further aspect of the example monocoque one-piece tube-like temple pre-form of FIG. 2, in accordance with the principles of the present disclosure.

FIG. 5 illustrates a perspective view of a frontside of a second smart glasses components module.

FIG. 6 illustrates an exploded view of the second smart glasses components module of FIG. 5.

FIG. 7 illustrates a backside perspective view of a portion of the smart glasses components assembly of FIG. 4.

FIG. 8A and FIG. 8B illustrate an example button that may be coupled of the smart glasses components assembly of FIG. 4.

FIG. 9A illustrates an opening or aperture that may be formed in a sidewall of the monocoque temple pre-form of FIG. 2.

FIG. 9B illustrates a removable window or cover disposed over the opening or aperture in temple pre-form illustrated in FIG. 9A.

FIG. 10 illustrates a temple pre-form that is a mirror image of the temple pre-form of FIG. 2.

FIG. 11 illustrates an example of a second pre-assembled module of smart glasses components.

FIG. 12A illustrates an example speaker module.

FIG. 12B illustrates the speaker module of FIG. 12A aligned to be introduced in a temple pre-form.

FIG. 12C illustrates the speaker module of FIG. 12A seated in the temple pre-form of FIG. 12B.

FIG. 13 illustrates the second pre-assembled module of FIG. 11 with an end slid into a support slot of the speaker module of FIG. 12C.

FIG. 14 illustrates a removable window or cover disposed over an opening or aperture in a sidewall SW of the temple pre-form illustrated in FIG. 12C.

FIG. 15 illustrates another side view of the window or cover that covers the aperture or opening in a bottom wall of the temple pre-form illustrated in FIG. 12C.

FIG. 16 illustrates an example method for fitting a temple of a pair of smart glasses with smart glasses components.

FIG. 17 illustrates another example method for fitting a temple of a pair of smart glasses with smart glasses components.

It should be noted that these FIGS. are intended to illustrate the general characteristics of methods, structures, and/or materials utilized in certain example embodiments and to supplement the written description provided below. These drawings are, however, not to scale and may not precisely reflect the precise structural or performance characteristics of any given embodiment, and should not be interpreted as defining or limiting the range of values or properties encompassed by example embodiments. For example, the relative thicknesses and positioning of components of the described eyeglasses may be reduced or exaggerated in the drawings for clarity. In the drawings, which are not necessarily drawn to scale, like reference symbols or alpha numerals may indicate like and/or similar components (elements, structures, etc.) in different views. The drawings illustrate generally, by way of example, but not by way of limitation, various implementations discussed in the present disclosure. Reference symbols shown in one drawing may not be repeated for the same, and/or similar elements in related views. Reference symbols or alpha-numeral identifiers that are repeated in multiple drawings may not be specifically discussed with respect to each of those drawings but are provided for context between related views. Also, not all like elements in the drawings are specifically referenced with a reference symbol or alpha-numeral identifier when multiple instances of an element are illustrated.

### DETAILED DESCRIPTION

Smart glasses eyewear (“smart glasses”) may be a wearable, voice- and/or motion-controlled device that resembles a pair of eyeglasses and displays information directly in the wearer's field of vision. The smart glasses may include two half-frames to hold a pair of see-through lenses in front of a person's eyes.

The two half-frames may be joined to form a spectacle frame. Further, the smart glasses may include temples (arms) (e.g., a right temple and a left temple) that are attached to respective ends of the two half-frames.

Smart glasses can be eyewear (i.e., a pair of glasses, also known as glasses, eyeglasses or spectacles) configured as a vision aid. The smart glasses can consist of glass or hard plastic lenses mounted in a frame that holds them in front of a person's eyes, typically utilizing a nose bridge over the nose, and legs (known as temples or temple pieces) that rest over the cars. In general, the smart glasses eyewear may include prescription glasses, reading spectacles, non-prescription glasses, fashion eyewear (tinted and clear), sunglasses, ski, and safety goggles, and more. For example, the eyewear can be smart glasses that can add information (e.g., augmented reality (AR) information including text, audio and/or video information) alongside what the wearer sees through the glasses.

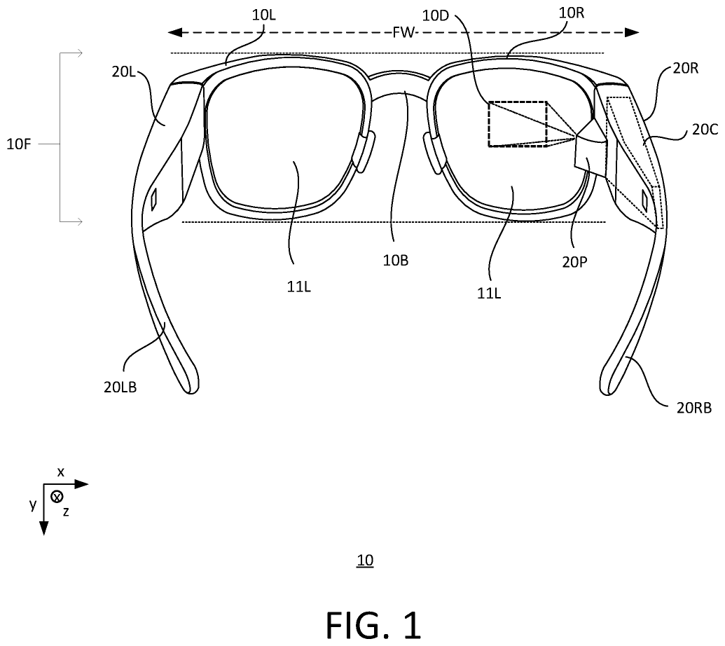

FIG. 1 illustrates an example pair of smart glasses (e.g., glasses 10) that can add information (e.g., on an in-lens display 10D) alongside what a wearer views through the glasses.

Glasses 10 may be a wearable, voice- and/or motion-controlled device that resembles a pair of eyeglasses and displays information directly in the wearer's field of vision. Glasses 10 may include two half-frames 10R and 10L to hold a pair of see-through lenses (e.g., lenses 11L) in front of a person's eyes. In some example implementations, a virtual display (e.g., display 10D) may be overlaid on, or embedded in, at least one of the pair of sec-through lenses 11L held in the two half-frames 10R and 10L. In some implementations, display 10D may be a projected display on which additional information can be optically projected alongside what the wearer views through the glasses. In some implementations, display 10D may be an in-lens micro display.

The two half-frames 10R and 10L may be joined using wires, bands, and/or other joining means to form a spectacle frame 10F (hereinafter “frame”, or “eyeglasses frame”). The joining means can include a nose bridge portion (e.g., nose bridge 10B). Spectacle frame 10F may have a front width FW (e.g., in an x direction) that may be selected to match, for example, an car-to-car face width of the person using the eyewear.

Further, glasses 10 may include temples (arms) (e.g., a right temple 20R and a left temple 20L) that are attached to respective ends of the two half-frames 10R and 10L. Right temple 20R and left temple 20L may extend generally perpendicular to the two half-frames 10R and 10L, for example, in a y-direction. Each of the temples (e.g., right temple 20R and left temple 20L) may have a length extending from the front portion of the frame (i.e., frame 10F) sufficient for the temples to reach over resting positions on the person's ears when frame 10F is positioned in front of the person's eyes. In some implementations, each of the temples (e.g., right temple 20R and left temple 20L) may include respective bent portions (e.g., right temple bend 20RB and left temple bend 20LB, respectively) that can be curved behind the person's ears, for example, to hold the glasses in place (e.g., to prevent the glasses from sliding forward) when the person's head is tilted downward.

In some example implementations, one or both two temple pieces 20L and 20R attached to eyeglasses frame 10F may include a compartment (e.g., compartment 20C) to hold electronics and other optical, mechanical, and electrical components (hereinafter smart glasses components”) (not shown) of the smart glasses. The smart glasses components held in compartment 20C may, for example, include one or more of processors, control circuits, batteries, optical projectors, speakers, microphones, eye-tracking cameras, inertial measurement units (IMU, or other circuitry, and may be used to add information (e.g., on display 10D) alongside what the wearer views through the glasses. In some implementations, some of the smart glasses components (e.g., a projector 20P) may protrude from a side of the temple. FIG. 1 shows, for example, projector 20P protruding from a side of temple 10R. Projector 20P that may be configured to project information on display 10D.

In example implementations, spectacle frame 10F and temples 20L and 20R may be made from plastics or polymeric materials (e.g., including thermoplastic materials such as nylon, polypropylene, polyethylene, polyvinylchloride, polystyrene, polyethylene terephthalate (PET), or polycarbonate, etc.). The adjustable bent portions (e.g., right temple bend 20RB and left temple bend 20LB, respectively) of the temples may, for example, include stiffening metal wire or rods encased in plastic or epoxy (not shown).

In traditional implementations, temples 10L and 10R may be assembled from multiple pieces or parts. Each temple may, for example, have a structure assembled from multiple pieces (e.g., a clam shell structure, a box-with-lid structure, or a two-part structure with front and back halves) to enclose a waterproof compartment (e.g., compartment 20C) in which the smart glasses components are held. The temple structures may be assembled by joining the multiple pieces (using, e.g., lap joints) to form the compartments (e.g., compartment 20) in the body of the temples to hold the smart glasses components. The lap joints may then be sealed to waterproof the compartment using, for example, a waterproof sealant (e.g., an O-ring, gasket, epoxy, or adhesive, etc.). The temple structures constructed from the multiple pieces can have significant wall and waterproof-sealed lap joint thicknesses. For example, a typical plastic wall thickness may be about 0.8 mm and a typical waterproof-sealed lap joint thickness may be about 1.4 mm. These wall and lap joint thicknesses can be a significant proportion of the temple volume. For example, for a temple with cross-sectional dimensions of 11×6 sqmm, the wall and lap joint seals may take up 15-20% of the volume of the temple.

Furthermore, one or more adjustable items (e.g., bent portions such as right temple bend 20RB and left temple bend 20LB, windows and meshes, etc.) may be attached or added to the multi-piece temples as separate components. These adjustable items, which may be added to the temple structures using additional hardware (e.g., screws, adhesives, clips, snaps, welds, etc.), also consume a fraction of the temple volume.

In some example implementations, one or both two temples attached to the two half-frames may include a compartment to hold electronics and other optical, mechanical, and electrical components (hereinafter “smart glasses components”) of the smart glasses. The smart glasses components held in the compartment, for example, include one or more of processors, control circuits, batteries, optical projectors, optical windows, speakers, microphones, audio meshes, heat spreaders, sensors, or other circuitry, and may be used to add information alongside what the wearer views through the glasses and or sense information from around the glasses.

There is a consumer demand for slimmer temples of smart glasses, and at the same time for the temples to include more and more optical, mechanical, and electrical components. However, the traditional multi-piece temple structures (e.g., clam shell, box-with-lid, etc.) do not lend themselves to the construction of slimmer temples (which are more comfortable and desired by users) without also sacrificing the volume of the compartment for holding the smart glasses components.

A monocoque (i.e., one piece) shell or tube-shaped temple structure (“monocoque temple”) may be used for making slim smart glasses. The monocoque temple has a one-piece seamless shell (tube) structure that can have ultra-thin shell (tube) walls. The shell (tube) walls can enclose a hollow compartment to hold smart glasses components. The monocoque temple may be made of plastic or plastic composite materials, or metals such as aluminum or titanium. In example implementations, the monocoque temple may be fabricated using, for example, injection molding or compression molding to form the hollow tube-like shell of the monocoque temple.

In example implementations, the thicknesses of the shell walls of the tube-shaped monocoque temple surrounding the hollow enclosed compartment may have a thickness T. In some implementations, the thickness T may be less than about 1.0 mm. In some implementations, the thickness T may be between about 0.3 mm and 0.4 mm (e.g., less than half the thickness of walls in traditional multi-piece temples (FIG. 1)).

In example implementations, openings or apertures may be formed (e.g., machined) in the monocoque shell structure to accommodate externally accessible interfaces of the smart glasses components (e.g., optical windows, speaker and microphone meshes, control buttons, etc.) that may be held in the enclosed compartment.

The present disclosure describes use of a monocoque temple pre-form for constructing a smart glasses temple. The monocoque temple pre-form includes a one-piece seamless shell structure that has shell walls enclosing a hollow compartment. An opening at one end of the one-piece seamless shell structure provides physical access to an inside volume of the hollow compartment.

In an aspect, one or more smart glasses components are placed in the hollow compartment through the opening in the shell structure of the monocoque temple pre-form. The monocoque temple pre-form with the one or more smart glasses components disposed in the hollow compartment is attached to a frame of the smart glasses. Several smart glasses components (e.g., processors, control circuits, batteries, optical projectors, speakers, microphones, etc.) are needed for functioning of the smart glasses. The limited volume of the hollow compartment and the limited access to the hollow compartment, for example, through the small-size opening at one end of the monocoque temple pre-form restricts the size and shape of the smart glasses components that can be fitted one-by-one in the hollow compartment.

The present disclosure describes a method for pre-assembling modules of smart glasses components outside the monocoque temple pre-form, and then inserting the modules one-by-one in the monocoque temple pre-form. The different pre-assembled modules may each include a single smart glasses component or a plurality of interconnected smart glasses components. The modules may be configured to connect to each other using, for example, plug-in or blind mating interfaces including features (such as pogo pins, springs, etc.) that do not require extensive manipulation inside the monocoque temple pre-form to interconnect the different smart glasses component modules.

In an example implementations, a first pre-assembled module for insertion in the hollow compartment of the monocoque temple pre-form may be a speaker module.

A second pre-assembled module may include various smart glasses components (e.g., microphones, an eye-tracking camera, a master logic board (MLB), and other electronic components (e.g., a wireless charger), etc.) that may be mounted or supported a circuit board (e.g., printed circuit board (PCB)). The various smart glasses components in the second pre-assembled module may be electrically interconnected to each other using flexible tape connectors (a “flex connector”). The flex connectors may be made, for example, of copper or another conductor.

The second pre-assembled module including the circuit board may be sized so that it can be inserted in the hollow compartment of the monocoque temple pre-form and coupled to the preceding first pre-assembled module (i.e., the speaker module) inserted in the hollow compartment of the monocoque temple pre-form.

In an example implementations, the circuit board may be attached to, supported, or assembled on a metal carrier. The metal carrier may provide structural strength and rigidity to the assembly.

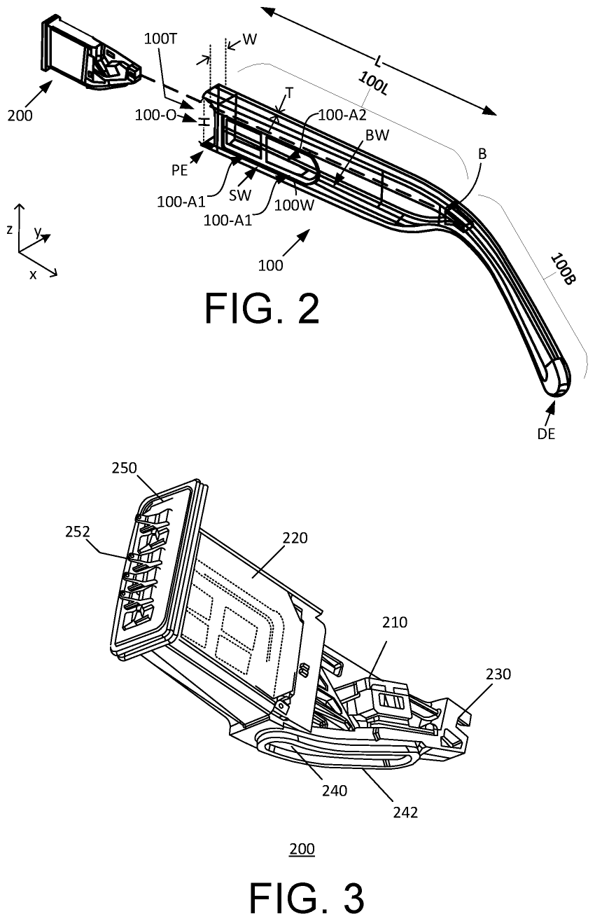

FIG. 2 shows an example monocoque temple pre-form 100 that may be fitted with smart glasses components, in accordance with the principles of the present disclosure. Monocoque temple pre-form 100 may be attached to a smart glasses frame (not shown) to become, for example, the left temple or arm of a pair of smart glasses that rests over the left car of wearer.

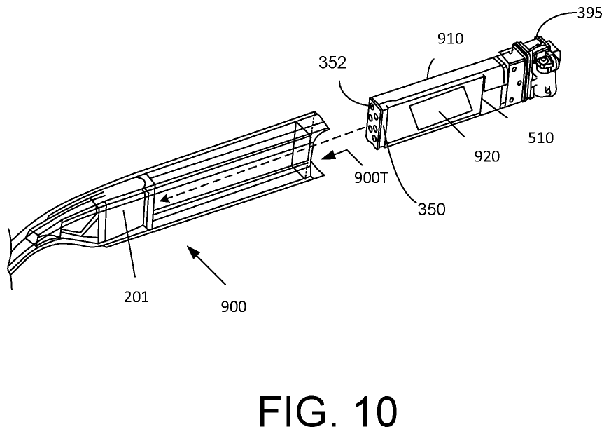

A similar temple pre-form (e.g., a mirror image) (temple pre-form 900, FIG. 10) may be used to construct the right temple of the pair of smart glasses.

Temple pre-form 100 may include a hollow tube-like compartment or enclosure (e.g., enclosure 100T) of length L that can be filled with one or more smart glasses components (e.g., processors, control circuits, batteries, optical projectors, speakers, microphones, etc.) needed for functioning of the smart glasses. Temple pre-form 100 may be made of molded plastic materials, for example, by injection molding or compression molding of the plastic materials. As shown in FIG. 1, temple pre-form 100 includes a substantially straight or linear section (e.g., linear section 100L) extending (e.g., in the x direction) from a proximal end PE toward a bent section 100B ending at a distal end DE. Linear section 100L of temple pre-form 100 may include an open-ended tube-like enclosure 100T that is formed between thin walls (e.g., walls 100W) of the linear section 100L. Enclosure 100T may have a bottom B before transitioning to bent section 100B. Enclosure 100T may have any three-dimensional shape (e.g., a cylinder with a round cross-section, a rectangular cross-section, or a rounded rectangular cross-section, etc.). A cross-section of enclosure 100T may, for example, have a rectangular, square, trapezoidal, oval, or circular shape.

In example implementations, enclosure 100T may have a length L and a generally rectangular cross-section having a height H and a width W. In example implementations, height H and width W may each be a few millimeters (mms) in size. In an example implementation, H may be equal to about 16 mm and W may be equal to about 10 mm.

In example implementations, walls 100W may have a thickness T that is less than 0.5 mm in dimension. In an example implementation, the thickness T may, for example, be between about 0.3 and 0.4 mm or less as may be determined by the materials and the manufacturing processes used.

In example implementations, the inside volume of enclosure 100T may be physically accessible through an opening (e.g., opening 100-O) at the proximal end PE of temple pre-form 100. Opening 100-O may have a height H (e.g., in the z direction) and a width W (e.g., in the y direction). Opening 100-O may be configured to allow insertion and placement of pre-assembled modules of smart glasses components (e.g., microphone, speakers, projectors, etc.) (e.g., speaker module 200, FIG. 2) in enclosure 100T of temple pre-form 100.

In example implementations, additional openings, or apertures (e.g., aperture 100-A1, aperture 100-A2, etc.) may be formed (e.g., machined or milled) in the walls of enclosure 100T to accommodate placement of externally accessible interfaces of smart glasses components held in enclosure 100T. The smart glasses components that may have externally accessible interfaces may include, for example, on-off switches for audio-related components such as microphone meshes and speakers, and optics-related components such as ambient light sensors, and optical projection devices. In the example shown in FIG. 1, aperture 100-A1 may be formed, for example, in a sidewall SW of enclosure 100T, and aperture 100-A2 may be formed, for example, in a bottom wall BW of enclosure 100T.

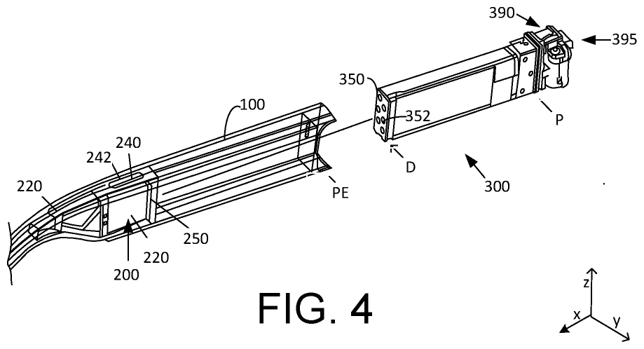

FIG. 3 illustrates a pre-assembled module (e.g., speaker module 200) that includes a smart glasses component (e.g., a speaker and speaker electronics) for fitting in enclosure 100T, FIG. 2.

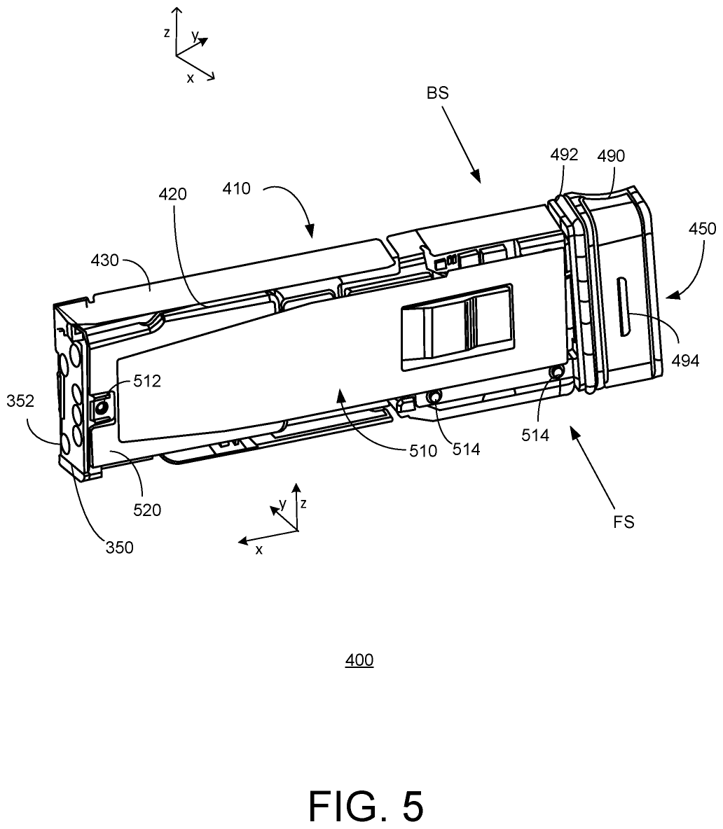

FIG. 4 illustrates the pre-assembled module of FIG. 3 fitted in the example monocoque temple pre-form of FIG. 2.

In example implementations, speaker module 200 may include a speaker 210 and associated electronic components (e.g., speaker electronics 220) in a housing made, for example, of plastics and metals. The housing may be configured or shaped to fit in enclosure 100T. A distal end of speaker module 200 (e.g., end 230) may be shaped to fit, for example, the bottom B of enclosure 100T (see FIG. 2). The distal end of speaker module 200 (e.g., end 230) have a shape that is generally conformal with a shape of the bottom B of enclosure 100T. In some example implementations, when speaker module 200 is inserted in enclosure 100T, the speaker module may be held in place at the bottom of enclosure 100T, for example, by an adhesive such as a dab of glue or other type of adhesive (not shown). In some example implementations, the speaker module may be held in place at the bottom of enclosure 100T, by a mechanical snap device. In example implementations, the speaker module housing may include an acoustic mesh 240 circumscribed by a surrounding foam stack 242. Foam stack 242 may acoustically seal speaker module 200 against the walls of enclosure 100T when speaker module 200 is placed at the bottom B of enclosure 100T.

Additional smart glasses components (logic circuits, eye-tracking camera, wireless charger, etc.) (in addition to the components in the speaker module) may be packaged in a second pre-assembled module (e.g., module 300, FIG. 4) for fitting in enclosure 100T.

In example implementations, a proximal end of speaker module 200 (inserted in enclosure 100T) may include an electrical connector mechanism (e.g., pogo pins, pins and sockets, micro-USB connectors, etc.). This electrical connector mechanism may be configured to blindly mate (i.e., without requiring human intervention) with a corresponding electrical connector mechanism on the second smart glasses components module (e.g., module 300, FIG. 4) that may be subsequently inserted enclosure 100T.

In example implementation, the proximal end of the speaker module may include a base plate 250 having an arrangement of metal springs (e.g., springs 252) that can provide electrical connections to the second smart glasses component module (e.g., module 300, FIG. 4).

In an example implementation, as shown in FIG. 4, the second smart glasses component module (e.g., module 300) may have an end plate 350 disposed on a distal end D of the module 300. End plate 350 may include an arrangement of contact pads 352 at its distal end D. The electrical connections of speaker module 200 to the second smart glasses component module (e.g., module 300) may be made by (metal) springs 252 on base plate 250 of speaker module 200 contacting (e.g., touching or pressing against) the contact pads (e.g., contact pads 352) on end plate 350 in module 300. In example implementations, end plate 350 in module 300 may be formed of a material (e.g., copper) similar to the material of a flex connector. A proximal end P of module 300 may include a cap feature 390 that extends into a hinge portion 395. Hinge portion 395 may be used as a part of a hinge which attaches temple pre-form 100 including enclosure 100T to a smart glasses frame (not shown).

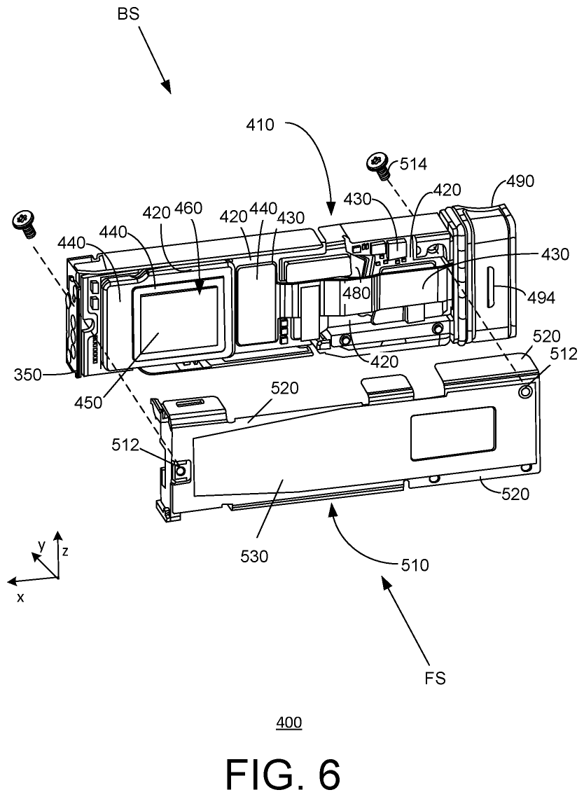

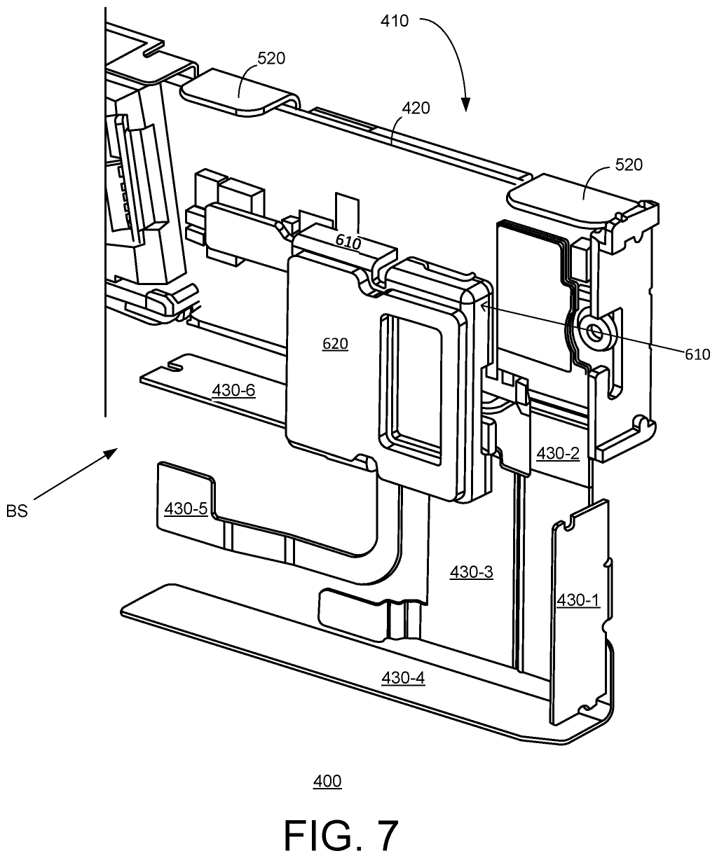

FIG. 5 and FIG. 6 show perspective views of a frontside (FS) of a second smart glasses components module (e.g., module 400). Features and components of module 400 on its backside (BS) are not visible in the frontside views shown in FIG. 5 and FIG. 6.

The second smart glasses components module (e.g., module 400) may include additional smart glasses components (in addition to speaker 210) that may be placed in enclosure 100T of temple pre-form 100 for fuller functionality of the smart glasses. The smart glasses components (not visible in FIG. 5) may, for example, include microphones, an eye-tracking camera, an inertial measurement unit (IMU), a system on a chip (SoC), a master logic board (MLB), a wireless charger and other electronic components, etc. These smart glasses components may be mounted or assembled (e.g., as a smart glasses components assembly 410) on a circuit board (e.g., printed circuit board (PCB)) (e.g., PCB 420) and may be interconnected using a flexible tape connectors (e.g., flex connector 430). PCB 420 may, for example, be a main logic circuit board for the smart glasses electronics.

In some example implementations, the second smart glasses components module (e.g., module 400) may include a sheet metal carrier or cover 510 extending over and backing the circuit board (e.g., PCB 420) in smart glasses components assembly 410. Sheet metal carrier or cover 510 may provide mechanical strength and rigidity to module 400. Sheet metal carrier or cover 510 may be made of a sheet of metal (e.g., sheet metal 520). Sheet metal carrier or cover 510 may be, as shown in FIG. 5 and FIG. 6, attached to module 400, for example, by screws 514 passing through corresponding screw holes (e.g., screw holes 512) in cover 510 and assembly 410. Further, in example implementations, the second smart glasses components module (e.g., module 400), like module 300 (FIG. 4), may have an end plate 350 with an arrangement of contact pads 352 for electrical connection to a preceding module (e.g., speaker module 200, FIG. 3, FIG. 4) when module 400 is inserted in enclosure 100T of temple pre-form 100.

Smart glasses components module 400 (as shown in FIG. 5 and FIG. 6) may include a capping fixture 490 (at an end opposite the end plate 350). Capping fixture 490 may include an O-ring 492 for sealing the enclosure opening (e.g., opening 100-O, FIG. 2) when smart glasses components module 400 is fully inserted in enclosure 100T of temple pre-form 100. Further, capping fixture 490 may include a snap-on button 494, that can be activated, for example, to retain or release module 400 from enclosure 100T of temple pre-form 100. FIG. 6 shows an exploded view of smart glasses components module 400 with the sheet metal carrier or cover 510 detached from smart glasses components assembly 410 (e.g., after removing the screws (e.g., screw 514) from the corresponding screw holes (e.g., screw holes 512).

FIG. 6 shows some additional details of smart glasses components assembly 410 that are not visible in FIG. 5. As shown in FIG. 6, screws 514 can be used to mount the printed circuit boards (e.g., PCB 420) and the flex connectors (e.g., flex connector 430) in assembly 410 on a sheet metal carrier or cover 510. The sheet metal carrier or cover 510 provides mechanical strength and rigidity to module 400. Further, in example implementations, sheet metal pieces (e.g., sheet metal piece 440) may be used to back board-to-board flex connectors (e.g., flex connector 430) so that the connections are robust.

In example implementations, a shield can (e.g., can 460) may be formed on a portion of PCB 420 (e.g., using sheet metal piece 440) to shield electronic components on PCB 420 from radio frequency (rf) and electromagnetic interference (EMI). The shielded electronic components may, for example, include system-on-chip (SOC) components or other integrated circuits.

In some example implementations, a layer of thermal interface material (e.g., TIM 450) may be disposed on sheet metal piece 440 (e.g., between sheet metal piece 440 and sheet metal carrier or cover 510) to provide a thermal path for heat conduction between sheet metal piece 440 and sheet metal carrier or cover 510.

In example implementations, an eye-tracking camera 480 may be disposed on or attached to PCB 420.

Further, as shown in the frontside perspective view of FIG. 6, in some example implementations, a layer of conductive material (e.g., layer 530) may be disposed over cover 510 to distribute heat more evenly across cover 510 and to reduce any thermal hot spots across cover 510. Layer 530 may include conductive material such as carbon, or graphite.

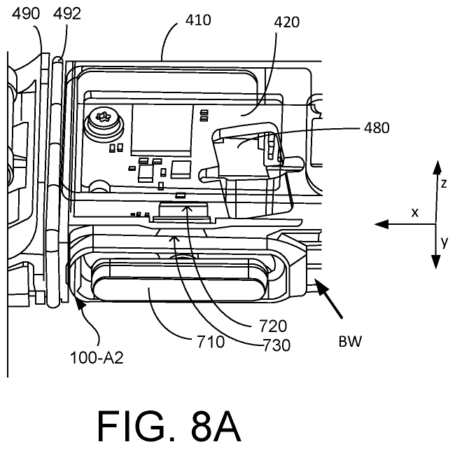

In some example implementations, additional flex connectors may be available for making board-to-board connections or other connections in the temple pre-form, In addition to the sheet metal carriers or covers (e.g., cover 510, FIG. 5 and FIG. 6)) and sheet metal pieces (e.g., sheet metal piece 440, FIG. 6) used to back board-to-board flex connectors deployed on the frontside of smart glasses components assembly 410, an additional cover (e.g., cover 610, FIG. 7) may be deployed to hold additional flex connectors on the backside of smart glasses components assembly 410.

FIG. 7 shows a backside (BS) perspective view of a portion of smart glasses components assembly 410. As shown in FIG. 7, a backside cover 610 (e.g., a plastic snap-on cover) may be deployed on the backside BS to hold additional flex connectors. In the example shown, backside carrier or cover 610 (made of plastic) may contain or support a set of flex connectors (e.g., flex connector 430-1, flex connector 430-2, flex connector 430-3, flex connector 430-4, flex connector 430-5, and flex connector 430-6). These flex connectors with multiple functionalities may be used to minimize a number of the connectors needed on the main PCB (e.g., PCB 420). An adhesive foam layer 620 may be disposed on the backside cover 610 containing the set of flex connectors.

FIG. 7 shows these flex connectors in a preliminary unfolded state before they are used to connect to the smart glasses components. In example implementations, folds, and shelves in the sheet metal carriers (cover 510) may be used to mount the various flex connectors. All board-to-board connections (e.g., flex connections) in smart glasses components assembly 410 may be backed by foam and sheet metal pieces (e.g., sheet metal piece 440, FIG. 6).

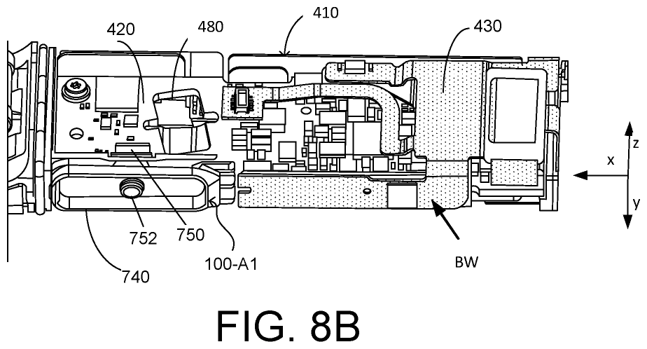

As noted previously (with reference to FIG. 2) various openings or apertures (e.g., aperture 100-A1, aperture 100-A2, etc.) may be formed (e.g., machined or milled) in the walls of enclosure 100T to accommodate placement of externally accessible interfaces of smart glasses components held in enclosure 100T. FIG. 8A and FIG. 8B illustrate an example button 710 that may be coupled (e.g., through aperture 100-A2) to smart glasses components assembly 410 placed in enclosure 100T of temple pre-form 100. Button 710 may, for example, activate a switch (e.g., switch 720) via a plastic plunger 730. Switch 720 may, for example, be an on-off switch for the main logic board.

As shown in FIG. 8B, a rubber grommet 740 disposed over a plastic plunger 750 can be used to seal the temple pre-form 100 around button 710. Rubber grommet 740 may allow a user to operate button end 752 of plastic plunger 750 by touch (e.g., by clicking) to activate switch 720. Switch 720 may, for example, be a system power on-off switch for the main logic board. Switch 720 may be moved between open and closed positions to switch the power on or off.). In some implementation, button 710 may also function as a mechanical grip that a cover over aperture 100-A2 can be slid off during assembly of the monocoque (e.g., by an operator) to gain access to the interior of the monocoque through aperture 100-A2.

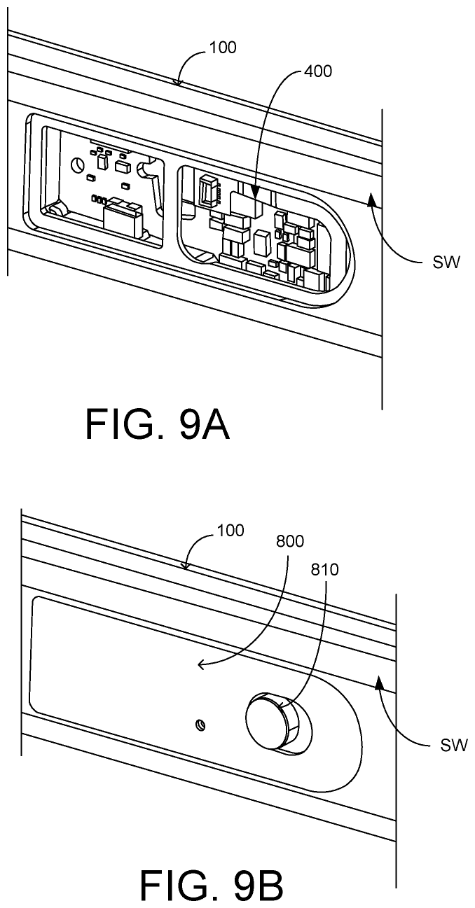

In example implementations, as shown in FIG. 9A, the second smart glasses components module (e.g., module 300, module 400) inserted in enclosure 100T of temple pre-form 100 (e.g., in addition to the previously inserted speaker module 200) may be accessible through the openings or apertures (e.g., aperture 100-A1) that may be formed, for example, in a sidewall SW of enclosure 100T (FIG. 2). An assembler (e.g., a technician or user) may access the smart glasses components module (e.g., module 300, module 400) through aperture 100-A1) to complete assembly steps including, for example, connecting or adjusting the flex connectors, reorienting the eye-tracking camera, etc.

In example implementations, as shown in FIG. 9B, a window or cover (e.g., cover 800) may be disposed over aperture 100-A1 in temple pre-form 100. Cover 800 may seal aperture 100-A1 of the monocoque. In addition to sealing the monocoque, cover 800 may be used as a base for mounting other components. For example, microphones or other components may be mounted on cover 800. For example, FIG. 9B shows a slider switch 810 mounted on window 800, In an example implementations, slider switch 810 may have an on/off function, a momentary state for Bluetooth pairing, a reset function, etc.

As noted earlier, monocoque temple pre-form 100 (FIG. 2) may be attached to a smart glasses frame (e.g., glasses 10, FIG. 1) to become, for example, the left temple or arm of a pair of smart glasses that rests over the left ear of wearer. FIG. 10 shows a monocoque temple pre-form 900 (e.g., a mirror image of temple pre-form 100) that may be used to construct the opposite handed temple (i.e., right temple) of the pair of smart glasses that rests over the right car of wearer. Temple pre-form 900 may include a hollow tube-like compartment or enclosure (e.g., enclosure 900T).

In example implementations, enclosure 900T may be configured to carry a battery (battery 920) of the smart glasses in addition to a speaker assembly (e.g., a speaker module 201, like speaker module 200). In example implementations, battery 920 may be mounted (e.g., with an adhesive) on a sheet metal carrier or cover (e.g., cover 510) to form a module 910. Speaker module 201 may be placed at a bottom of enclosure 900T and then module 910 may be inserted in enclosure 900T. Speaker contact pads 352 on end plate 350 of module 910 may carry speaker signals to the rest of the smart glasses system over battery flex connectors (not shown).

The foregoing describes the second pre-assembled modules (e.g., module 300, 400) in which several smart glasses components (e.g., smart glasses components assembly 410) are mounted on a circuit board (e.g., PCB 420). The circuit board itself is backed up, supported, or structurally reinforced by a metal carrier (e.g., a sheet metal carrier or cover 510. FIG. 5 and FIG. 6).

In some example implementations, a second pre-assembled module or module may be constructed without utilizing a metal carrier for structural reinforcement of the PCB board. This approach reduces the weight of the temples used in the smart glasses. The PCB board (e.g., PCB 420) itself is used a carrier to support the smart glasses components (e.g., the electronic components and the flex connectors). A thin plastic cover may be screwed or snapped on to the PCB to back the flex connectors on PCB 420.

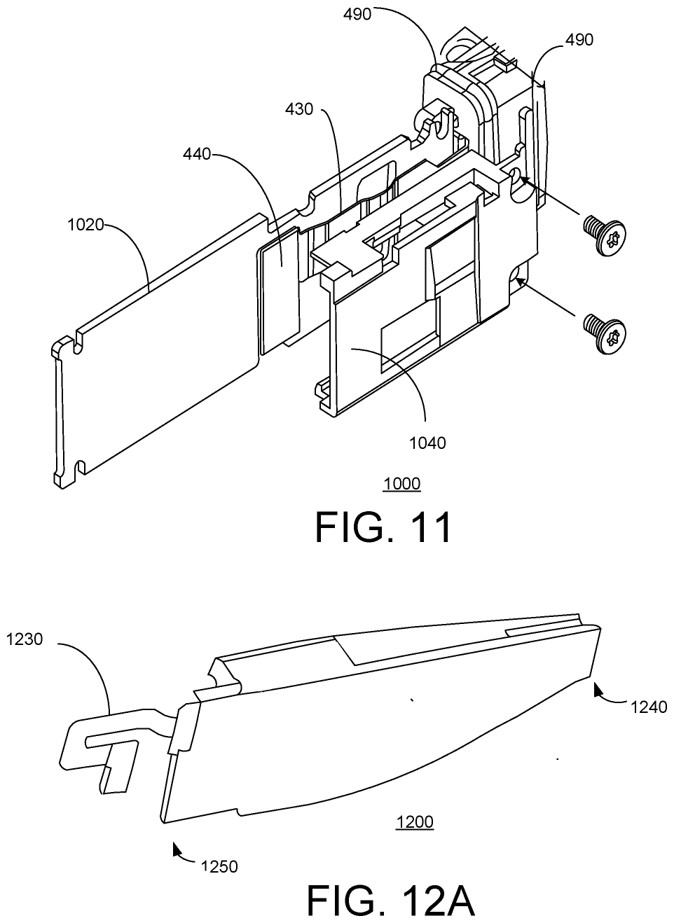

FIG. 11 shows an example second pre-assembled module (e.g., module 1000) of smart glasses components constructed on a printed circuit board (PCB 1020) without use of a metal carrier (e.g., cover 510, FIG. 5) for reinforcement. The smart glasses components on PCB 1020 may be electrically connected by flex connectors (e.g., flex connector 430). Further, a thin plastic cover (e.g., cover 1040) may be screwed or snapped on to the PCB 1020 to back the flex connectors (e.g., flex connector 430).

In example implementations, module 1000 may be configured to be coupled to a speaker module using flex connectors (instead of the arrangements of springs 252 and contact pads 352 shown, e.g., in FIGS. 3 through 6).

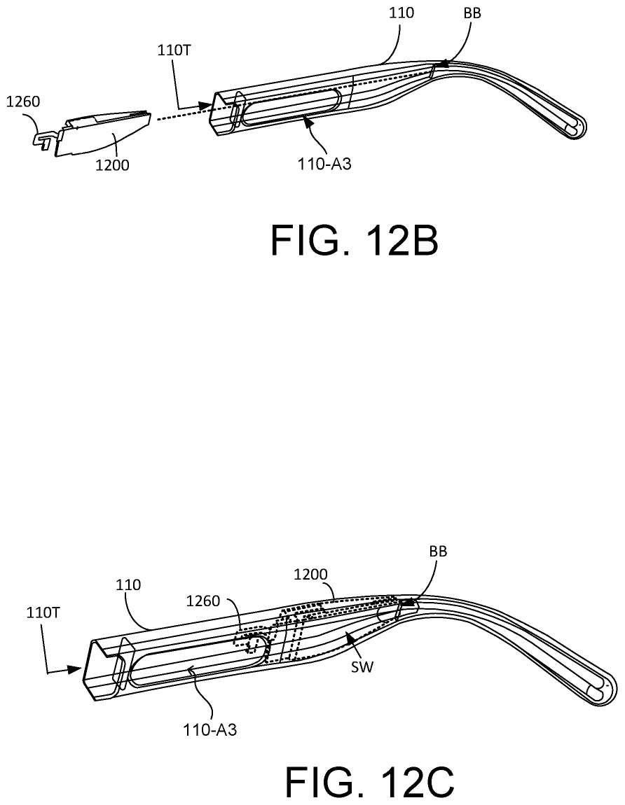

FIG. 12A shows an example speaker module 1200 which may be used in conjunction with module 1000 to fit smart glasses components in a temple pre-form. Speaker module 1200 may be a housing made, for example, of plastics and metals. The housing may be configured or shaped to fit in an enclosure 110T of monocoque temple pre-form 110 (FIG. 12B and FIG. 12C). A distal end (e.g., end 1240) of speaker module 1200 may be shaped to fit, for example, a bottom BB of enclosure 110T (see FIG. 12B). Speaker module 1200, like speaker module 200 (FIG. 3), may include a speaker and associated electronic components (not shown). The speaker and the speaker electronics may be connected to a hook-like conductive board-to-board connector (e.g., connector 1230) extending out from a proximal end (e.g., end 1250) of the speaker module 1200.

FIG. 12B shows speaker module 1200 aligned to be introduced in tubular enclosure 110T of temple pre-form 110. FIG. 12C shows speaker module 1200 seated, for example, at bottom BB of enclosure 110T. Speaker module 1200 may be held in place with a snap (e.g., an interference fit) or a dab of glue or adhesive (not shown) at bottom BB of enclosure 110T.

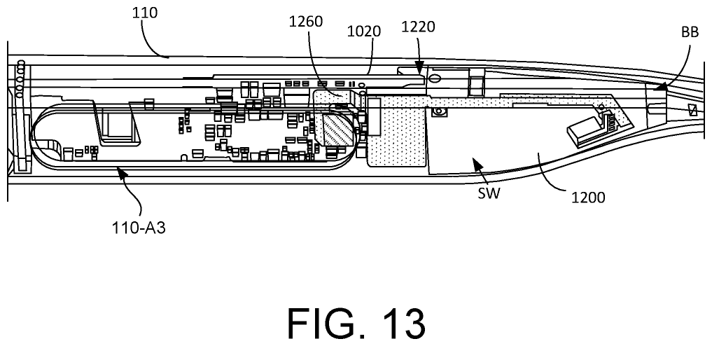

As shown in FIG. 12C, once fully inserted in enclosure 110T, and seated at the bottom BB, the hook-like conductive board-to-board connector (e.g., connector 1260) of speaker module 1200 may extend along an opening (e.g., aperture 110-A3) in sidewall SW of temple pre-form 110. Further, as shown in FIG. 13, in example implementations, to fit the smart glasses components in monocoque temple pre-form 110, the second pre-assembled module (e.g., module 1000, FIG. 11) may be inserted in enclosure 110T so that an end of PCB 1020 slides into a support slot (e.g., slot 1220) in speaker module 1200 held in place at bottom BB of enclosure 110T.

In example implementations, as shown in FIG. 13, the second smart glasses components module (e.g., module 1000) inserted in enclosure 110T of temple pre-form 110 (e.g., in addition to the previously inserted speaker module 1200) may be accessible through an opening (e.g., aperture 110-A3) in sidewall SW of temple pre-form 110 formed, for example, in a sidewall SW of enclosure 110T (FIG. 12C).

An assembler (e.g., a technician or user) may access the smart glasses components module (e.g., module 1000) and speaker module 1200 through aperture 110-A3 to complete assembly steps including, for example, connecting connector 1230 of speaker module 1200 to PCB 1020.

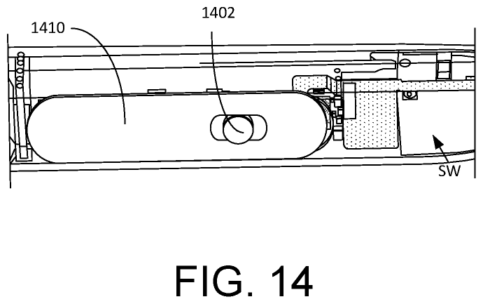

In example implementations, as shown in FIG. 14, a cover (e.g., cover 1410) may be disposed over the opening or aperture (e.g., aperture 110-A3) in sidewall SW temple pre-form 110. Cover 1410 may include a have a slider switch 1402 installed through it.

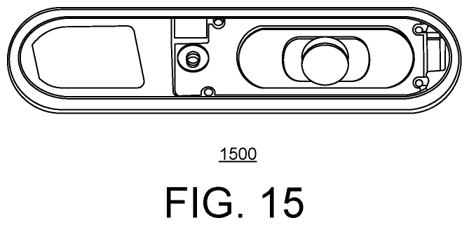

FIG. 15 shows another window (e.g., window 1500) that may cover another aperture or opening (e.g., in a bottom wall of in temple pre-form 110) that may provide access to components fitted in enclosure 110T.

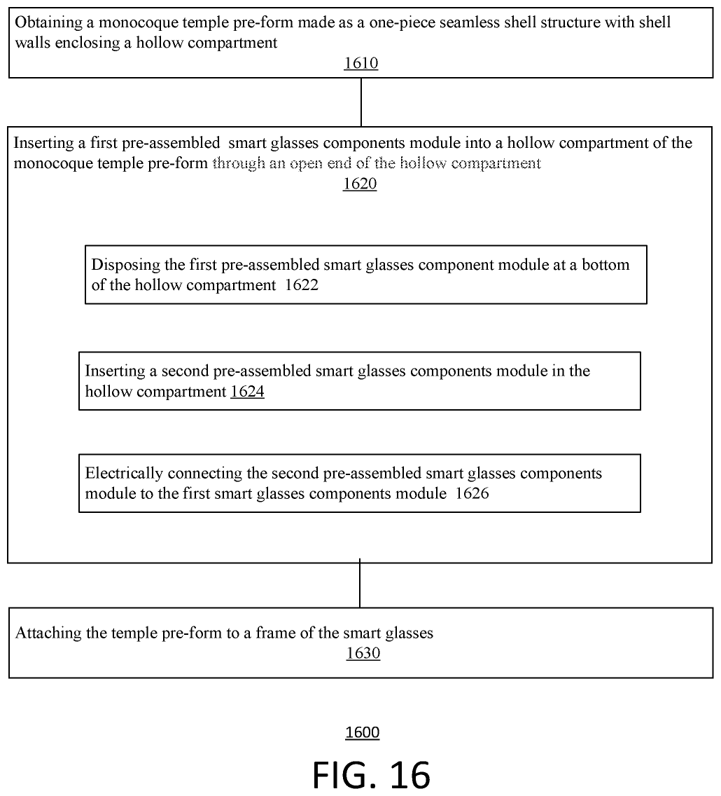

FIG. 16 illustrates an example method 1600 for fitting a temple of a pair of smart glasses with smart glasses components, in accordance with the principles of the present disclosure.

Method 1600 begins with obtaining a monocoque temple pre-form made as a one-piece seamless shell structure with shell walls enclosing a hollow compartment (1610). An opening at one end of the one-piece seamless shell structure provides physical access to an inside volume of the hollow compartment. The monocoque temple pre-form may, for example, be temple pre-form 100 shown in FIG. 2, or temple pre-form 900 shown in FIG. 10.

Method 1600 further includes inserting a first pre-assembled smart glasses components module into the hollow compartment of the monocoque temple pre-form through an open end of the hollow compartment (1620), and attaching the temple pre-form to a frame of the pair of smart glasses (1630).

In example implementations, the shell walls of the seamless shell structure enclosing the hollow compartment may have a thickness equal to or less than about 1.0 mm (e.g., equal to or less than about 0.4 mm).

In example implementations, the hollow compartment may have a length between about 60 mm and 100 mm, a width (perpendicular to the length) equal to or less than about 10 mm (e.g., equal to or less than about 8 mm), and a height (perpendicular to the length and the width) equal to or less than about 20 mm (e.g., equal, or less to about 12 mm).

In example implementations, inserting the first pre-assembled smart glasses components module into the hollow compartment of the monocoque temple pre-form through the open end of the hollow compartment 1620 includes disposing the first pre-assembled smart glasses component module at a bottom of the hollow compartment (1622), and inserting a second pre-assembled smart glasses components module in the hollow compartment (1624). Inserting the first pre-assembled smart glasses components module into the hollow compartment of the monocoque temple pre-form through the open end of the hollow compartment 1610 further includes electrically connecting the second pre-assembled smart glasses components module to the first smart glasses components module (1626).

The two modules may be electrically interconnected using, for example, plug-in or blind mating interfaces (including feature such as pogo pins, springs, and contact pad pairs, etc.) that do not require extensive manipulation inside the monocoque temple pre-form to interconnect the first and second smart glasses component modules.

In example implementations of method 1600, the first smart glasses components module may be a speaker module including a speaker and associated speaker electronics. The speaker module may include a base plate at its proximal end with an arrangement of metal springs. The second smart glasses components module may have an end plate at its distal end with an arrangement of contact pads. In example implementation, the speaker module may require a flexible electrical interconnection to the rest of the system (such as the spring fingers for a flexible printed circuit) so that the speaker can acoustically seal to the external speaker port at the back of the cavity in the monocoque (while a second pre-assembled smart glasses components module seals the front of the monocoque to form a water proof seal there).

In example implementations, electrically connecting the second pre-assembled smart glasses components module to the first smart glasses components module may include contacting the contact pads on the end plate of the second smart glasses components module with the metal springs on a base plate of the speaker module.

In example implementations, the first pre-assembled smart glasses component module is a speaker module including a speaker and speaker electronics, and disposing the first pre-assembled smart glasses component module at a bottom of the hollow compartment includes attaching the first pre-assembled smart glasses component module to the bottom with a dab of glue.

In example implementations, the speaker module housing includes an acoustic mesh circumscribed by a surrounding foam stack, and disposing the first pre-assembled smart glasses component module at a bottom of the hollow compartment include using the foam stack to (acoustically) seal the speaker module against a wall of the hollow compartment.

In example implementations, electrically connecting the second pre-assembled smart glasses components module to the first smart glasses components module may include contacting a contact pad on an end plate of the second smart glasses components module with a metal spring on a base plate of the speaker module. The second smart glasses components module can seal the front of the monocoque to form a waterproof seal.

In example implementations, the second pre-assembled smart glasses component module includes a circuit board on which one or more smart glasses components are mounted, a flexible tape connector electrically connected to at least one of the one or more smart glasses components mounted on the circuit board, and a sheet metal carrier. The circuit board is attached to and supported by the sheet metal carrier.

In example implementations, the method further includes disposing a sheet metal piece to back a board-to-board flexible tape connection on the circuit board.

In example implementations, the method may further include disposing a layer of thermal interface material (TIM) between the sheet metal piece and the sheet metal carrier.

In example implementations, the method may further include disposing a layer of graphite on a surface of the sheet metal carrier.

In example implementations, the method may further include forming a sheet metal can on the circuit board to shield electronic components on the circuit board from radio frequency (rf) and electromagnetic interference (EMI).

In example implementations, the method may further include accessing the second pre-assembled smart glasses components module through a window in a sidewall of the hollow compartment to make a flexible tape connection, reroute a flexible tape connection, or reorient a smart glasses component.

In example implementations, the method may further include disposing an O-ring around a top of the second pre-assembled smart glasses components module to seal an ingress path between the second pre-assembled smart glasses components module and a sidewall of the hollow compartment.

In example implementations, the monocoque temple pre-form may be a first monocoque temple pre-form of the smart glasses, and the method further includes obtaining a second monocoque temple pre-form made as a one-piece seamless shell structure with shell walls enclosing a hollow compartment, and disposing a battery in the second monocoque temple pre-form.

In example implementations, the second pre-assembled smart glasses component module includes a circuit board on which one or more smart glasses components are mounted, and a flexible tape connector that is electrically connected to at least one of the one or more smart glasses components mounted on the circuit board.

Further, in example implementations, in the second pre-assembled smart glasses component module, the circuit board is attached to and supported by a metal carrier.

In example implementation, the method includes disposing a sheet metal piece to back a board-to-board flexible tape connector on the circuit board.

In example implementations, the shell walls enclosing the hollow compartment can include one or more apertures adapted to provide an externally accessible interface to a smart glasses component held in the hollow compartment (e.g., the smart glasses component being one of a speaker, a microphone, an on-off button, and an optical window, etc.).

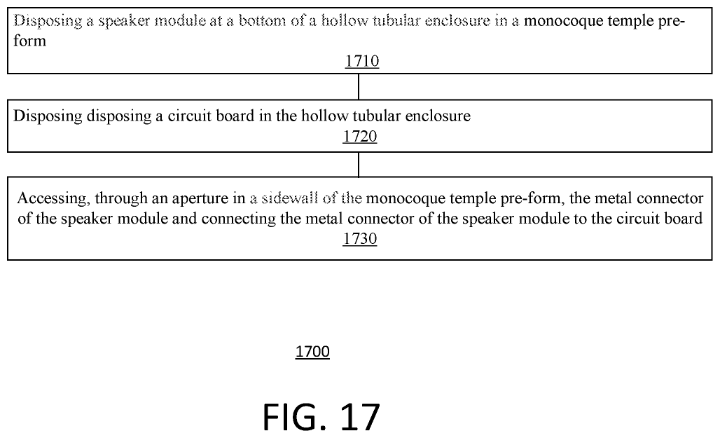

FIG. 17 illustrates an example method 1700 for fitting a temple of a pair of smart glasses with smart glasses components, in accordance with the principles of the present disclosure.

A method 1700 includes disposing a speaker module at a bottom of a hollow tubular enclosure in a monocoque temple pre-form (1710). The speaker module includes a speaker and associated electronics embedded in a plastic housing. A metal connector of the speaker module extends from the plastic housing;

Method 1700 further includes disposing a circuit board in the hollow tubular enclosure (1720). A plurality of smart glasses components are mounted on the circuit board with at least a flexible tape connector (made of copper) electrically connecting at least one of the plurality of smart glasses components.

Method 1700 further includes accessing, through an aperture in a sidewall of the monocoque temple pre-form, the metal connector of the speaker module and connecting the metal connector of the speaker module to the circuit board (1730).

In the foregoing method 1700, disposing the circuit board in the hollow tubular enclosure includes snapping or screwing a plastic cover on to the circuit board to back connectors between the plurality of smart glasses components on the circuit board.

In the foregoing method 1700, disposing the circuit board in the hollow tubular enclosure includes sliding an end of the circuit board into a support slot in the speaker module at a bottom of a hollow tubular enclosure.

While example embodiments may include various modifications and alternative forms, embodiments thereof are shown by way of example in the drawings and description herein. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor (e.g., a processor formed on a silicon substrate, a GaAs substrate, and the like) or some other programmable data processing apparatus.

Some of the above example embodiments are described as processes or methods depicted as flowcharts. Although the flowcharts describe the operations as sequential processes, many of the operations can be performed in parallel, concurrently, or simultaneously. In addition, the order of operations can be re-arranged. The processes can be terminated when their operations are completed, but may also have additional steps not included in the figure. The processes may correspond to methods, functions, procedures, subroutines, subprograms, etc.

Methods discussed above, some of which are illustrated by the flow charts, can be implemented by hardware, software, firmware, middleware, microcode, hardware description languages, or any combination thereof. When implemented in software, firmware, middleware or microcode, the program code or code segments to perform the necessary tasks can be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements can be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

The terms “substantially.” “nearly,” and “about” may be used herein to describe and account for small fluctuations, such as due to variations in processing or assembly. For example, these terms can refer to less than or equal to ±5%, less than or equal to ±2%, less than or equal to ±1%, less than or equal to ±0.5%, less than or equal to ±0.2%, less than or equal to ±0.1%, or less than or equal to ±0.05%. Also, when used herein, an indefinite article “a” or “an” means “at least one.”

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that can be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium can be magnetic (e.g., a floppy disk or a hard drive) or optical (e.g., a compact disk read only memory, or CD ROM), and can be read only or random access. Similarly, the transmission medium can be twisted wire pairs, coaxial cable, optical fiber, or some other suitable transmission medium known to the art. The example embodiments are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method for making smart glasses, the method comprising:
obtaining a monocoque temple pre-form made as a one-piece seamless shell structure with shell walls enclosing a hollow compartment, the hollow compartment having an open end;
inserting a first pre-assembled smart glasses components module into the hollow compartment through the open end of the hollow compartment;
disposing the first pre-assembled smart glasses components module at a bottom of the hollow compartment, the bottom being opposite the open end;
inserting a second pre-assembled smart glasses components module through the open end of the hollow compartment;
electrically connecting the second pre assembled smart glasses components module to the first pre-assembled smart glasses components module; and
attaching the monocoque temple pre-form to a frame of the smart glasses.

2. The method of claim 1, wherein the first pre-assembled smart glasses components module is a speaker module including a speaker and associated speaker electronics, and wherein disposing the first pre-assembled smart glasses components module at the bottom of the hollow compartment includes attaching the first pre-assembled smart glasses components module to the bottom with an adhesive.

3. The method of claim 2, wherein the speaker module includes an acoustic mesh circumscribed by a surrounding foam stack, and wherein disposing the first pre assembled smart glasses components module at the bottom of the hollow compartment includes disposing the surrounding foam stack against a wall of the hollow compartment to seal the speaker module.

4. The method of claim 3, wherein electrically connecting the second pre-assembled smart glasses components module to the first pre-assembled smart glasses components module includes contacting a contact pad on an end plate of the second pre-assembled smart glasses components module with a metal spring on a base plate of the speaker module.

5. The method of claim 1, wherein the second pre-assembled smart glasses components module includes:
a circuit board on which one or more smart glasses components are mounted;
a flexible tape connector electrically connected to at least one of the one or more smart glasses components mounted on the circuit board; and
a sheet metal carrier, the circuit board being attached to and supported by the sheet metal carrier.

6. The method of claim 5, further comprising:
disposing a sheet metal piece to back a board-to-board flexible tape connection on the circuit board.

7. The method of claim 6, further comprising:
disposing a layer of thermal interface material (TIM) between the sheet metal piece and the sheet metal carrier.

8. The method of claim 5, further comprising:
disposing a layer of graphite on a surface of the sheet metal carrier.

9. The method of claim 5, further comprising:
forming a sheet metal can on the circuit board to shield electronic components on the circuit board from radio frequency (rf) and electromagnetic interference (EMI).

10. The method of claim 1, further comprising:
accessing the second pre-assembled smart glasses components module through a window in a sidewall of the hollow compartment to make a flexible tape connection, reroute a flexible tape connection, or reorient a smart glasses component.

11. The method of claim 1, further comprising:
disposing an O-ring around a top of the second pre-assembled smart glasses components module to seal an ingress path between the second pre-assembled smart glasses components module and a sidewall of the hollow compartment.

12. The method of claim 1, wherein the monocoque temple pre-form is a first monocoque temple pre-form of the smart glasses, and wherein the method further comprises:
obtaining a second monocoque temple pre-form made as a one-piece seamless shell structure with shell walls enclosing a hollow compartment; and
disposing a battery in the second monocoque temple pre-form.

13. A method comprising;
disposing a speaker module at a bottom of a hollow tubular enclosure in a monocoque temple pre-form, the speaker module including a speaker and associated electronics embedded in a plastic housing, a metal connector of the speaker module extending from the plastic housing;
disposing a circuit board in the hollow tubular enclosure, a plurality of smart glasses components being mounted on the circuit board with at least a flexible tape connector electrically connecting at least one of the plurality of smart glasses components; and
accessing, through an aperture in a sidewall of the monocoque temple pre-form, the metal connector of the speaker module and connecting the metal connector of the speaker module to the circuit board.

14. The method of claim 13, wherein disposing the circuit board in the hollow tubular enclosure includes snapping or screwing a plastic cover on to the circuit board to back connectors between the plurality of smart glasses components on the circuit board.

15. The method of claim 13, wherein disposing the circuit board in the hollow tubular enclosure includes sliding an end of the circuit board into a support slot in the speaker module at the bottom of a hollow tubular enclosure.

16. A temple pre-form of a smart glasses temple, the temple pre-form comprising:
a one-piece seamless shell structure having shell walls enclosing a hollow compartment;
an opening at one end of the one-piece seamless shell structure providing physical access to an inside volume of the hollow compartment;
a first pre-assembled smart glasses components module disposed at a bottom of the hollow compartment, the bottom being at another end opposite the opening; and
a second pre-assembled smart glasses components module disposed in the hollow compartment above the first pre-assembled smart glasses components module proximal to the opening, the first pre-assembled smart glasses components module being electrically connected to the second pre-assembled smart glasses components module by a blind mating interface.

17. The temple pre-form of claim 16, wherein the first pre-assembled smart glasses components module is a speaker module including a speaker and associated speaker electronics, and wherein the first pre-assembled smart glasses components module is attached to the bottom of the hollow compartment with an adhesive.

18. The temple pre-form of claim 17, wherein the speaker module includes an acoustic mesh circumscribed by a surrounding foam stack, and wherein the first pre-assembled smart glasses components module is disposed with the surrounding foam stack pressed against a wall of the hollow compartment to seal the speaker module.

19. The temple pre-form of claim 16, wherein the second pre-assembled smart glasses components module includes:
a circuit board on which one or more smart glasses components are mounted;
a flexible tape connector electrically connected to at least one of the one or more smart glasses components mounted on the circuit board; and
a sheet metal carrier, the circuit board being attached to and supported by the sheet metal carrier.

20. The temple pre-form of claim 19, further comprising:
a sheet metal piece to back a board-to-board flexible tape connection on the circuit board.

21. The temple pre-form of claim 20, further comprising:
a layer of thermal interface material (TIM) disposed between the sheet metal piece and the sheet metal carrier.

22. The temple pre-form of claim 19, further comprising:
a layer of graphite disposed on a surface of the sheet metal carrier.

23. The temple pre-form of claim 19, further comprising:
a sheet metal can be disposed on the circuit board to shield an electronic component on the circuit board from radio frequency (rf) and electromagnetic interference (EMI).

24. The temple pre-form of claim 19, further comprising;
an O-ring disposed around a top of the second pre-assembled smart glasses components module to seal an ingress path between the second pre-assembled smart glasses components module and a sidewall of the hollow compartment.

25. A monocoque temple pre-form comprising;
a speaker module disposed in a hollow tubular enclosure in the monocoque temple pre-form, the speaker module including a speaker and associated electronics embedded in a plastic housing, a metal connector of the speaker module extending from the plastic housing; and
a circuit board disposed in the hollow tubular enclosure, a plurality of smart glasses components being mounted on the circuit board with at least a flexible tape connector electrically connecting at least one of the plurality of smart glasses components, the metal connector of the speaker module being connected to the circuit board.

26. The monocoque temple pre-form of claim 25, further comprising:
a plastic cover snapped or screwed on to the circuit board to back connectors between the plurality of smart glasses components on the circuit board.

27. The monocoque temple pre-form of claim 25, wherein an end of the circuit board is slid into a support slot in the speaker module at one end of the hollow tubular enclosure.
